(19) United States
(12) Patent Application Publication
(10) Pub. No.: US 2019/0226613 A1
(43) Pub. Date: Jul. 25, 2019

(54) PIPE CONNECTING APPARATUS

(71) Applicant: AFGlobal UK Limited, Knaphill Surrey (GB)

(72) Inventors: Kieren SCHNEIDER, Knaphill Surrey (GB); John WHITE, Knaphill Surrey (GB)

(21) Appl. No.: 16/306,474

(22) PCT Filed: Jun. 2, 2017
(86) PCT No.: PCT/IB2017/053286

§ 371 Date: Nov. 30, 2018

(30) Foreign Application Priority Data
Jun. 3, 2016 (GB) 1609720.6

(51) Int. Cl. F16L 23/08; F16L 1/26; F16L 23/18

(52) U.S. Cl. CPC F16L 23/08; F16L 23/18; F16L 1/26

(57) ABSTRACT

A pipe connecting apparatus for clamping flanged ends (26) of two pipes (28) comprises a first assembly (12) and a second assembly (14). Each assembly (12, 14) comprises a plurality of pipe engaging segments (16, 18) connected by an outer band (20) in an arcuate configuration. Each segment (16, 18) comprises a longitudinal arcuate channel (22) having tapered side walls (24) defining a channel (22) for receiving the flanged ends (26). The apparatus further comprises adjustable connecting members (32, 34) for connecting the first assembly (12) to the second assembly (14), so as to clamp the assemblies (12, 14) around the flanged ends (26).

This application claims the benefit of priority to United Kingdom Patent Application No. 1609720.6, filed Jun. 3, 2016, hereby incorporated by reference in its entirety.

This invention relates to a pipe connecting apparatus for securing the end of a pipe to another conduit. In particular the invention relates to a clamp type connector for pipes such as those used in the subsea oil and gas industry.

### BACKGROUND

Underwater connections between pipelines or with others installations such as flexible flowlines, manifolds and wellheads, are sealed together by the use of a ring gasket, which is held between the respective hubs of the pipeline and other installation. The hubs and the gasket are aligned and drawn together by a remotely operated tooling device and secured together by a clamp.

One type of connector used to secure hubs of subsea installations together is a clamp which consists of two solid components connected by a hinge at one end and single bolt at the other end, or bolts at both ends of the components for example the Retlock® clamp connector from AFGlobal UK Ltd. However these clamps can be heavy and expensive due to the amount of material involved. The single bolt version can also require a large torque input to achieve a required preload. Precision alignment can be required to ensure the appropriate seal is obtained.

Segmented clamps have also been proposed comprising multiple segments all connected together, with a single fastening means to secure the clamp. However opening and closing of the clamp can result in high levels of stress at the base of the clamp, and a large torque input can be required to reach the required preloads during make up. Additionally the retrieval from the sea floor of the fallible components, such as the shaft, nuts, washers, may be difficult with the single bolt versions and may require removal of the whole clamp assembly. This can be a time intensive operation for a remote operated vehicle (ROV), if at all possible.

The present invention seeks to provide an alternative pipe connecting apparatus for use with pipes and the like, subsea.

### DISCLOSURE OF THE INVENTION

The invention provides a pipe connecting apparatus for securing the end of a first pipe to the end of a second pipe or other installation, in subsea environments via their respective flanged hubs.

A first aspect of the invention comprises a pipe connecting apparatus for clamping flanged ends of two pipes or a pipe and another subsea installation, the apparatus comprising:

a first assembly and a second assembly, each assembly comprising a plurality of pipe engaging segments connected by an outer band in an arcuate configuration, wherein each segment comprises a longitudinal arcuate tapered channel defining a circumferential channel for receiving the flanged ends;

the apparatus further comprising two adjustable connecting members for connecting the first assembly to the second assembly, so as to clamp the assemblies around the flanged ends.

The channels are tapered, i.e. have outwardly inclined side walls, such that the opening of the channel is a greater width than the base of the channel. In one embodiment the side walls of the channel are tapered at an angle of from about 5° to 22°, 5° to 20°, 5° to 15°, 5° to 10°, or from 7° to 10° to the vertical. Preferably the side walls are tapered at an angle of from about 5° to 15° or from about 7° to 12° to the vertical. Both side walls are tapered at substantially the same angle.

For any given angle the capture of the apparatus can be increased by increasing the taper depth, however this will increase the bending stresses within the clamp segments and increase material costs. In one embodiment the depth of the channel can be from about 20 mm to 60 mm, 20 mm to 40 mm, or 25 mm to 35 mm. Preferably the depth of the channel is about 30 mm. A shallower depth reduces stress levels on the pipe engaging segments, however a shallower depth also reduces the clamp capture of the hubs. Larger channel depths create a greater lever arm and induce higher stresses within the pipe engaging segments. In one embodiment the channel can have a taper of from about 5° to 15° or from about 7° to 12° and a depth of about 25 mm to 35 mm.

In use, the tapered surfaces of the hubs of the pipes to be connected, mate with the tapered side walls of the channels of the pipe engaging segments of the apparatus. The first side wall mates with the first hub and the second side wall mates with the second hub.

Having tapered channels can reduce the risk of locking in the first stage of make up during installation of the connecting apparatus.

The pipe engaging segments can be coated with an anti-friction coating. Coatings providing low coefficient of friction can be used on the surface of the pipe engaging segments. Preferably the coating provides a friction co-efficient of about 0.02-0.06, preferably of about 0.04. An inorganic lubricant such as molybdenum disulphide can be used.

Each of the first and second assemblies of the pipe connecting apparatus comprises a plurality of pipe engaging segments. The term “plurality” means three or more, for example 3, 4, 5, or 6 or more pipe engaging segments. Therefore the pipe connecting apparatus will comprise at least six pipe engaging segments, at least three pipe engaging segments forming part of the first assembly and at least three pipe engaging segments forming part of the second assembly. Each assembly is comprised of inner pipe engaging segments and end pipe engaging segments. The end pipe engaging segments may also be known as outer pipe engaging segments and are the segments connected to the ends of the bands.

In higher pressure environments more segments can be used. Also the larger the diameter of the pipe to be clamped the more pipe engaging segments can be used. Preferably the first and second assemblies have the same number of pipe engaging segments. Preferably the invention can be used to produce a pipe connecting apparatus for use with pipes having a diameter of 20 inches (0.51 m) to 60 inches (1.52 m).

In one embodiment the first and second assemblies can each comprise three to five pipe engaging segments, i.e. the pipe connecting apparatus comprises six to ten pipe engaging segments. In one embodiment the first and second assemblies each comprise four pipe engaging segments, such that the pipe connecting apparatus comprises eight pipe engaging segments.

In one embodiment when a 36 inch (0.92 m) pipe is to be clamped the first and second assemblies can each comprise four pipe engaging segments. When a 60 inch (1.52 m) pipe is being clamped more segments can be used, for example five or more segments per assembly.

The individual segments are spaced apart and connected by an outer band such that they form an arcuate configuration. The individual segments may also be arcuate in shape. Providing the pipe connecting apparatus in the form of multiple spaced apart segments joined together with flexible bands, provides improved alignment of each segment with the flanged hub, providing improved tolerance for installing the apparatus around the hubs of the pipe. Having a plurality of segments may also result in less stress on the elements of the apparatus and less torque is required to achieve the required preload during make up.

Both end segments of each assembly comprise a lug for receiving one of the connecting members. These are the pipe engaging segments connected at the ends of the flexible outer band. The first and second assemblies each comprise two end (outer) pipe engaging segments, two lugs, i.e. each end pipe segment comprising an outwardly extending lug, and one or more inner pipe engaging segments. For example where the first and second assemblies each comprise four pipe engaging segments, the first and second assemblies each comprise two outer pipe engaging segments and two inner pipe engaging segments. Where the first and second assemblies each comprise three pipe engaging segments, the first and second assemblies each comprise two outer pipe engaging segments and one inner pipe engaging segments.

Each connecting members is received by two lugs, one lug on the first assembly and one lug of the second assembly. The lugs of the end pipe engaging segments extend axially out beyond the band to receive the connecting members. The lugs comprise an aperture through which the connecting member can extend. When in use the aperture of the first lug on the first assembly will align with the aperture of the first lug on the second assembly and the aperture of the second lug on the first assembly will align with the aperture of the second lug on the second assembly, such that the first connecting member can extend through the first lugs, and the second connecting member can extend through the second lugs to connect the first assembly to the second assembly.

The lug connected to each of the end segments comprises a recessed area and a hemispherical washer.

The recessed area is located about the aperture and provides a substantially concaved depression in the top surfaces of the lug. The hemispherical washer can be located within the recessed area.

The term “top” as used herein is relative and is understood to mean the outer surface of any component of the apparatus directed away from the pipe which is being clamped.

For example when the term top is used with respect to the depression in the lug, in the first assembly, which is to engage around the top of the pipe, the recessed areas are located in the top (outer) facing surfaces of the lugs about the aperture, away from the surface which engages with its respective lugs on the second assembly. With respect to the second assembly, which engages around the bottom of the pipe, the top surfaces in which the recessed areas are located are again the outer surfaces, which are located opposite from the lug surface that engages with its respective lug on the first assembly.

The use of hemispherical washers helps maintain a flat planar relationship between the nut and washer during installation during fastening of the nut about the bolt and reduces shaft bending due to tightening.

The apertures and passages for receiving the connecting members through the lugs of the first assembly can comprise a different configuration from apertures and passages for receiving the connecting members through the lugs of the first assembly. The configuration of the apertures and passage through the lugs will depend on the connecting members used. The apertures in the lugs of the first assembly can comprise a first configuration and the apertures in the lugs of the second assembly can comprise a second configuration.

In one embodiment the aperture in the top surface of the lugs of the second assembly can comprise a substantially cross shaped cross-section. The aperture in the top surface of the lugs of the first assembly can comprise a substantially circular cross section.

The pipe engaging segments of the first assembly are connected together by a first outer flexible band and the pipe engaging segments of the second assembly are connected by a second outer flexible band. The flexible band maintains the pipe engaging segments in an arcuate configuration. The shape formed by the flexible band and pipe engaging segments complementing the shape of the flanged hubs to be connected.

Each of the pipe engaging segments is individually secured to its respective band. At least part of the top surface of each individual segment abuts the bottom surface of the band. The bottom surface can be substantially flat. Although as described below slots may be present in the bottom surface to assist in securing the band to the segments.

The bands can be connected to the segments by connecting means, such as studs or bolts. Studs or bolts can extend through apertures in the band to engage the pipe engaging segments. One or more studs, bolts, or other connecting means may be used to secure each pipe engaging segment to the band. The band may be substantially the same width as the pipe engaging segments.

Other means for securing the band to each of the pipe engaging segments can also be used. For example each pipe engaging segment can be plug welded to the band, and/or a key and keyway mechanism may be used to connect the segments.

One mechanism to couple the band to the pipe engaging segments can comprise a key mechanism. The bottom surface of the band can comprise a keyway in the form of a slot which is configured to receive a key connected to the top surface of the pipe engaging segment. The key can be a raised protrusion on the top surface of the segment that is sized and configured to fit into the keyway located in the band. The keyway can be a slot in the bottom surface of the band that extends through the band, or the keyway may be a recess that extends partially into the surface having sidewalls and a base, to receive a correspondingly shaped key. The keyway may have a substantially rectangular cross-section that extends transversely across the width of the band. The keyway may extend partially across the width of the band.

The inner and end engaging segments are subjected to different forces during makeup. Therefore the end pipe engaging segments and the inner pipe engaging segments can be connected to the band by different and/or multiple mechanisms. In one embodiment the bands can be connected to the end pipe engaging segments by a first mechanism and the bands can be connected to the inner pipe engaging segments by a second mechanism. The band can be connected to the end pipe engaging segment by a further third mechanism. The third mechanism connecting the end pipe engaging segments to the band may be the same or different to the second mechanism connecting the inner pipe engaging segments to the band.

The end pipe engaging segments may comprise a further mechanism to secure the band segments. The further mechanism may comprise a butt plate strap or pocket configured such that the end of the band can slide into the strap or pocket.

In one embodiment the inner pipe engaging segments may be connected to the band to transfer load from the band to the segment and the end pipe engaging segments may be connected via a shear transfer mechanism, such as a shear key.

The inner pipe engaging segments can be connected to the band by bolts and the end pipe engaging segments can be connected via a key mechanism. The end pipe engaging segments can be connected to the band by two different mechanisms a key mechanism and bolts. The key mechanism helps transfer load in shear and the bolts secure the joint together stabilising the load through the key, this also secures the segments to the band.

The band and pipe engaging segments comprise steel and/or a steel alloy. In one embodiment the band and pipe engaging segments are composed of different materials. Different steel alloys can be used for the band and the pipe engaging segments. The pipe engaging segments can comprise the same material as the hubs. The material used can depend on the pressure requirements.

The adjustable connecting members are fasteners and can comprise a bolt and nut arrangement. The apparatus comprises two connecting members that can be tightened to close the clamp and secure the clamp about the pipes. A first connecting member connects the first ends of the first assembly and second assembly and a second connecting member connects the second ends of the first assembly and second assembly.

The connecting members are threaded connecting bolts. The bolts are fastened with the application of torque. In one embodiment of the bolt and nut arrangement one of the nuts used on the bolt may be a self-locking nut.

A further aspect of the invention comprises a method of securing a first pipe to a second pipe or further subsea installation comprising arranging the pipe connecting apparatus as described above around flanged hubs of the first pipe and second pipe or further installation; and applying torque to the connecting members of the pipe connecting apparatus to clamp the pipe connecting apparatus about the first pipe and second pipe or further installation.

The method can further comprise an engaging a torque device to each connecting member of the pipe connecting apparatus; and simultaneously applying torque to the first and second connecting members to clamp the pipe connecting apparatus. By using two connecting members less torque is required for a given preload, as compared to a single bolt used to connect a plurality of segments. It is provides an apparatus where less material is required, making the apparatus lighter and less expensive to manufacture.

### BRIEF DESCRIPTION OF THE DRAWINGS

Embodiments of the present invention will now be described, by way of example only with reference to the accompanying drawings, in which:

FIG. 1 is a front view of an embodiment of the clamp;

FIG. 2 is a front perspective view of an embodiment of the clamp; and

FIG. 3 is a side view of an embodiment of the clamp;

FIG. 4 is sectional view showing an embodiment of the clamp around hubs of pipes;

FIG. 5 is enlarged partial sectional view showing an embodiment of the clamp around hubs of pipes;

FIG. 6 is a sectional end view of the pipe engaging segments;

FIG. 7 is a front sectional view of an embodiment of the clamp;

FIG. 8 is a front sectional view of an embodiment of the clamp;

FIG. 9 is an enlarged partial sectional view of a an embodiment of the clamp and a fastening member;

FIG. 10A-D is views of an inner pipe engaging segment. FIG. 10A shows a side view;

FIG. 10B shows an end view, FIG. 100 shows a front perspective view and FIG. 10D shows a top view;

FIG. 11A-F is views of a top end pipe engaging segment. FIG. 11A shows a side view; FIG. 11B shows an end view, FIG. 11C shows a front perspective view; FIG. 11D shows a back perspective view; FIG. 11E shows a top perspective view, and FIG. 11F shows a bottom view;

FIG. 12A-C is views of a bottom end pipe engaging segment. FIG. 12A shows a bottom view; FIG. 12B shows a top view, and FIG. 12C shows a cross-sectional view;

FIG. 13 shows a view of connecting mechanisms for the band and end pipe engaging segments; and

FIG. 14 shows a sectional view of connecting mechanisms for the band and end pipe engaging segments.

### DETAILED DESCRIPTION OF THE INVENTION

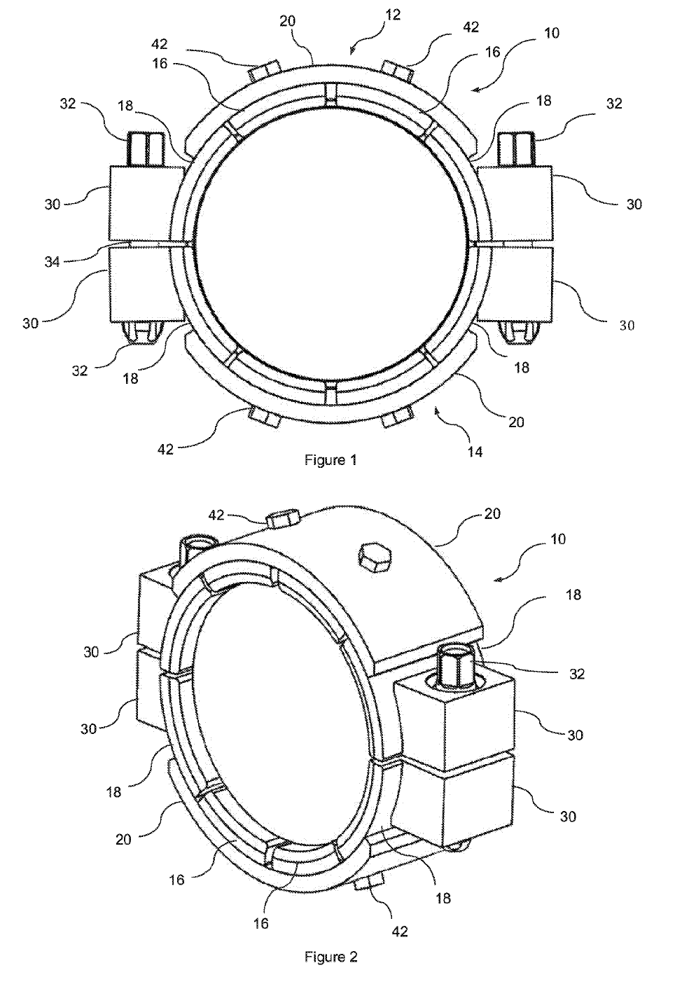

Referring to the drawings, FIG. 1 shows a pipe clamp 10 comprising a first assembly 12 and a second assembly 14. The assemblies are secured together at their respective first and second ends by fasteners by the application of torque to form a complete clamp which can be secured around the flanged hubs of two pipes to be connected. The first assembly can be located around the top of the pipe to be connected and the second assembly can be located around the bottom of the pipe to be connected.

Each of the assemblies 12, 14, have a plurality of pipe engaging segments 16, 18 and an external flexible band 20 connecting the pipe engaging segments. As shown in FIGS. 1 and 2 each assembly 12, 14 comprises four pipe engaging segments 16, 18 which are circumferentially spaced apart such that when the two assemblies are connected together a substantially circular opening through the clamp is formed.

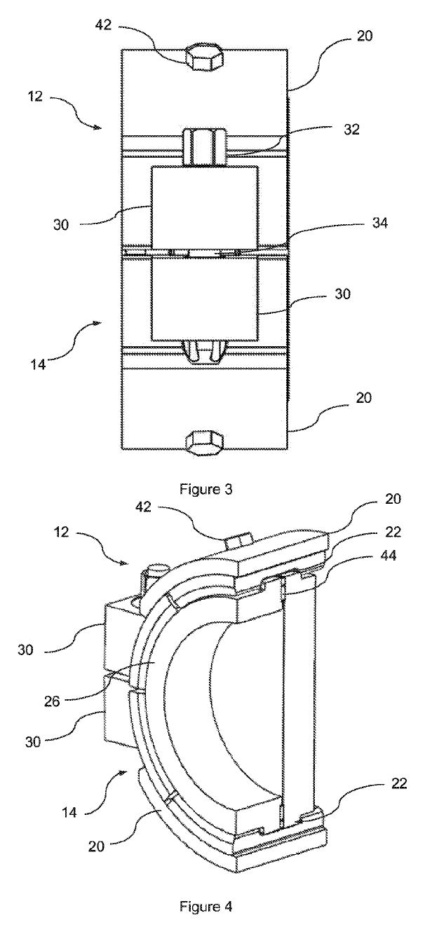

The clamp 10 comprises two flexible bands 20, one for each assembly 12, 14. Each pipe engaging segment 16, 18 is connected to its respective flexible band 20. For example as shown in FIGS. 1-5 and 7 the segments can be connected to the band by bolts 42 (not all shown), that extend through apertures in the band to the segments.

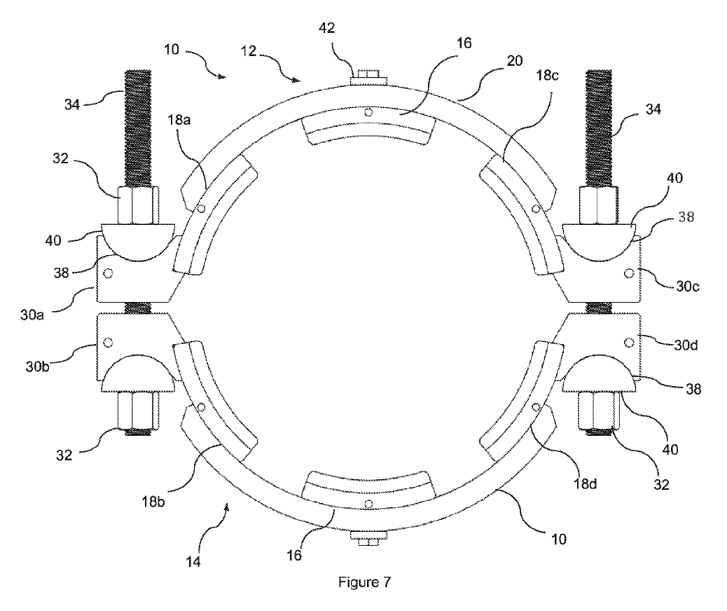

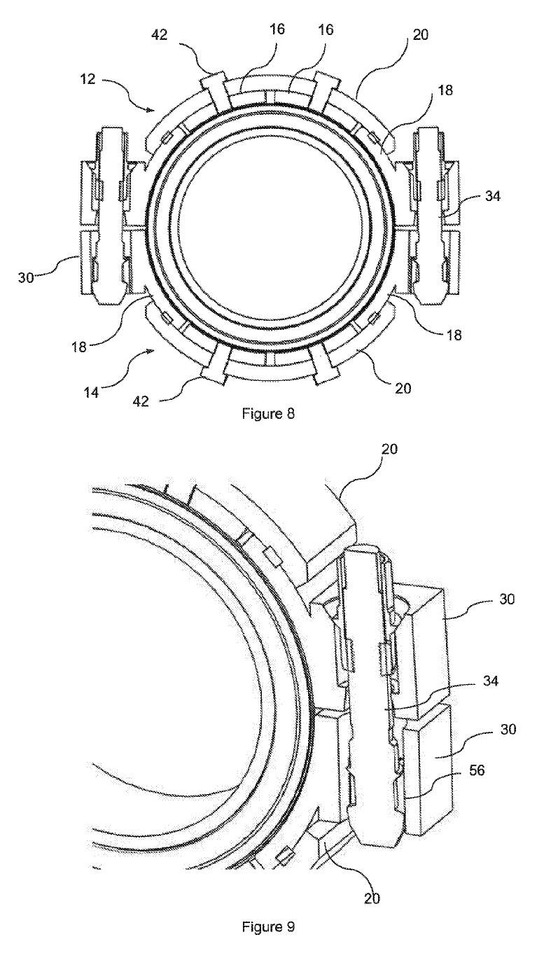

The pipe engaging segments are arcuate segments to complement the circular shape of the hubs of the pipes. The clamp comprises inner and outer pipe engaging segments. FIGS. 1, 2 and 8 show a clamp 10 comprising eight pipe engaging segments, each assembly having four pipe engaging segments. In other embodiments the clamp may have six pipe engaging segments, with each assembly comprising three pipe engaging segments as shown in FIG. 7 or the clamp may have ten or more pipe engaging segments, with each assembly comprising five or more pipe engaging segments. The number of segments can depend on the size of the pipe and the environment it is to be used. For example when a 36 inch (0.92 m) pipe is to be clamped to an installation the first and second assemblies can each comprise four pipe engaging segments. When a 60 inch (1.52 m) pipe is being clamped more segments may be used.

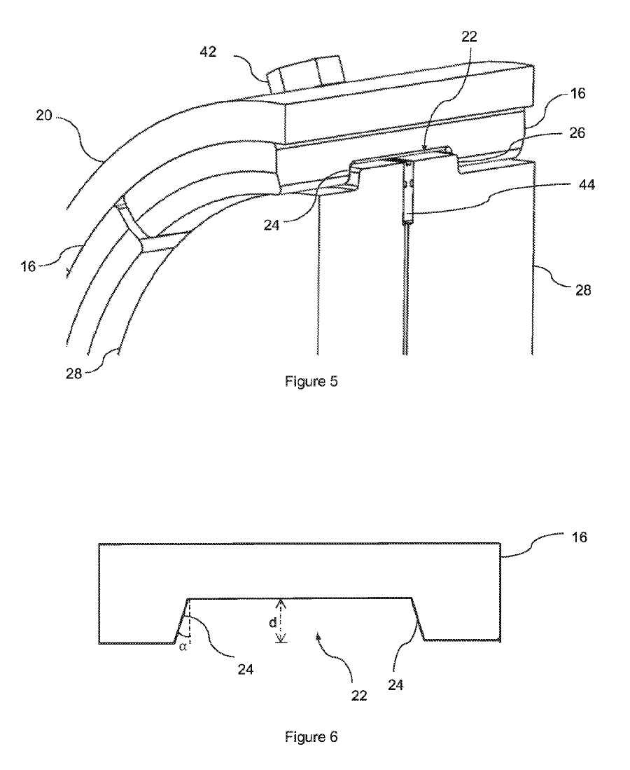

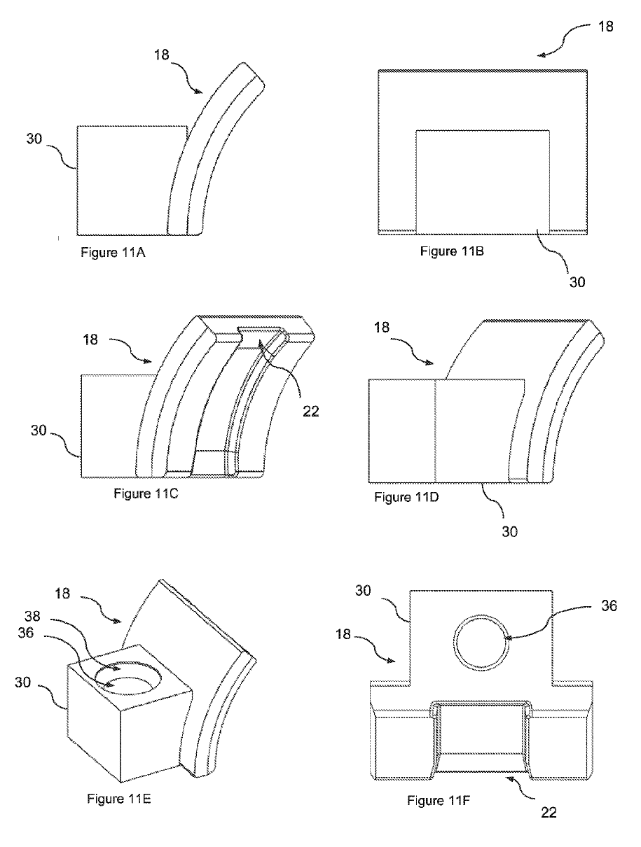

Referring to FIGS. 5-6 and 10-12 each of the pipe engaging segments 16, 18 comprises a channel 22 extending longitudinally along the length of the segment. The channels 22 are tapered, comprising a pair of outwardly inclining side walls 24 forming an opening of greater width than the base of the channel. The side walls of the channel taper at an angle, α, away from the vertical.

The hubs 26 of the each pipe 28 being connected have a flat faces with a seal ring groove in the face and the opposite side has a tapered surface. The tapered surfaces of the channels of the pipe engaging segments 16, 18 engage with complementary tapered surfaces on the hubs 26 of the pipes 28. The pipe engaging segments and the hubs are configured so that when the pipe engaging segments are positioned over the hub and the fasteners are tightened, the surfaces of the segments will forces the faces of the hubs into engagement.

In one embodiment the side walls of the channel taper at an angle of 7° from the vertical. In alternate embodiments the inclined walls of the segments may incline at an angle between approximately 5° to 22°, 5° to 20°, 5° to 15°, 5° to 10°, 7° to 12° or 7° to 10° from the vertical. The larger the angle the higher the stress that is placed on the clamp, whilst if the angle is too low then this can lead to locking due to friction, during make up of the clamp.

The depth of the channel will depend on the required capture. For any given angle the capture of the apparatus can be increased by increasing the taper depth, however this will increase the bending stresses within the clamp segments and increase material costs. In one embodiment the depth (d) of the channel can be from about 20 mm to 60 mm, 20 mm to 40 mm, or 25 mm to 35 mm. Preferably the depth of the channel is about 30 mm when used with a 36 inch (0.92 m) pipe. A shallower depth reduces stress levels on the pipe engaging segments, however a shallower depth also reduces the clamp capture of the hubs. Larger channel depths create a greater lever arm and induce higher stresses within the pipe engaging segments.

When the pipe engaging segments having a channel tapered about 7° and a channel depth of about 30 mm, the capture will be approximately 4 mm.

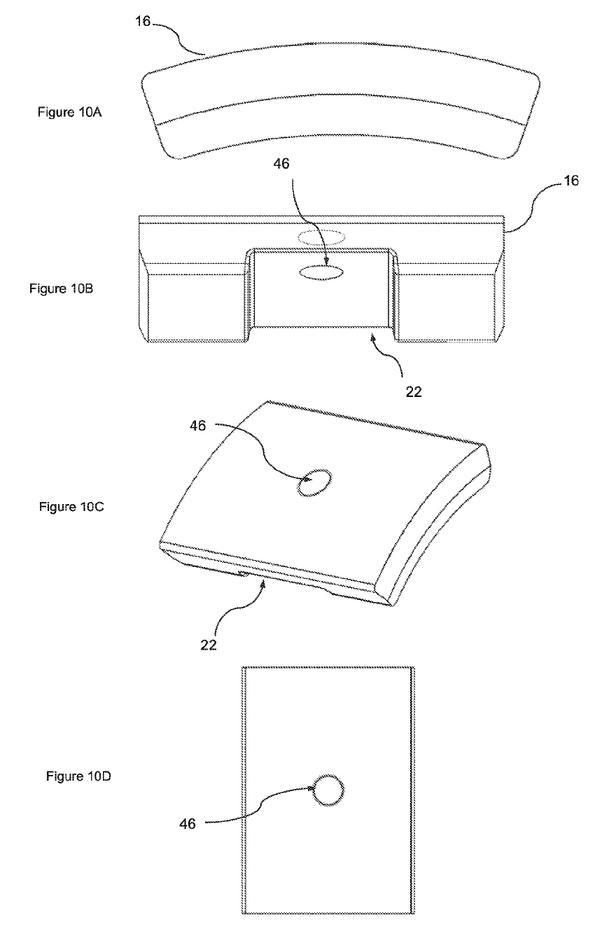

As shown in FIGS. 1 to 4 and 7-9 the clamp 10 comprises two outer bands 20, a first outer band 20 on the first assembly 12, and a second outer band 20 on the second assembly 14. Each of the pipe engaging segments 16, 18 is individually secured to its respective band 20. The bands can be connected to the segments by studs or bolts 42. The bands have a substantially flat bottom (inner) surface and comprises aperture through which the bolts can engage the pipe engaging segments and secure the segment to the band. The pipe engaging segments 16, 18 can have corresponding apertures 46 for receiving the bolts. One or more studs or bolts, or other connecting means may be used to secure each pipe engaging segment to the band.

A further mechanism to couple the band to the pipe engaging segments can comprise a key and keyway mechanism. The bottom surface of the band can comprise a keyway 50 in the form of a slot or recess which is configured to receive a key 48 connected to the top surface of the pipe engaging segment.

As shown in FIG. 12 the key 48 can be a raised protrusion on the top surface of the band that is sized and configured to fit into the keyway 50 located in the band. The key can be a corresponding slot in the bottom surface of the band. The keyway may have a substantially rectangular cross-section that extends transversely across the width of the band. The protrusion can have a corresponding substantially rectangular cross-section and extend transversely across the width of the end pipe engaging segments. The cross-sectional shape of the key and keyway may be other than generally rectangular, for example, they may be square, trapezoidal, triangular, semicircular, or some other selected shape. While the key has been shown on the pipe engaging segment, the key could be provided on the bottom surface of the band and the keyway located in the pipe engaging segment.

The inner and end (outer) engaging segments are subjected to different forces during makeup. The joint between the band and the end segments experience large lateral forces from the make-up of the clamp, with the band and end pipe engaging segments being pulled across each other. The joint between the inner pipe engaging segments and the bands experiences larger forces pushing the two parts together, with less lateral shear. Therefore different connecting mechanism can be used to connect the inner and the end (outer) engaging pipe segments to the bands.

The inner pipe engaging segments can be connected to the band to transfer load from the band to the segment. The end pipe engaging segments are connected to the band via a shear load transfer mechanism, such as a shear key.

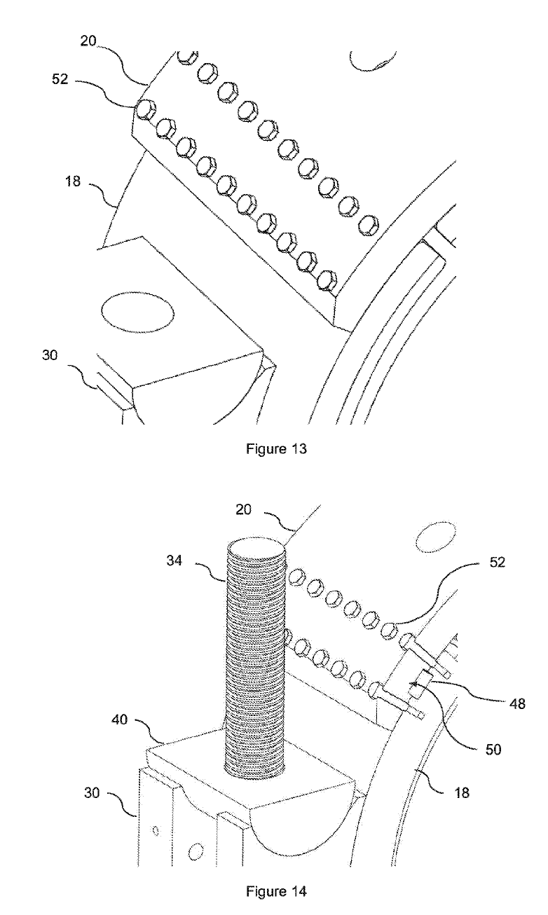

In one embodiment the inner pipe engaging segments can be connected to the band by bolts and the end pipe engaging segments can be connected via a key mechanism. As shown in FIGS. 13 and 14 the end pipe engaging segments 18 can be further secured to the band by a second mechanism. Bolts 52 extend through the band to engage with the end pipe engaging segments 18 such that the end pipe engaging segments is connected to the band by two different mechanisms, a key and keyway mechanism 48, 50 and bolts 52. The key helps transfer load in shear and the bolts secure the joint together, stabilising the load through the key. The bolts also secure the segments to the band.

Further means for connecting the end pipe engaging segments include a butt strap plate or a pocket (not shown) attached to the end pipe engaging segment for receiving the end of the band. The butt strap may be formed from a butt plate connected to the top surface of the end pipe engaging segments. The end of the band can slide under the strap or into the pocket to assist the band being held in position. The key and/or bolts can further hold the band in position.

In one embodiment as shown in FIGS. 1 and 7 the band can extend along the full length of the inner pipe engaging segments 16, such that the full length of the top surface of the inner pipe engaging segment abuts the bottom surface of the band. The band 20 extends along a portion of the end pipe engaging segments 18, such that a partial length of the top surface of the end pipe engaging segment abuts the bottom surface of the band. The lugs 30 of the end pipe engaging segments 18 extend axially out beyond the band to receive the connecting bolts 34. Preferably the band is substantially the same width as the pipe engaging segments.

Each assembly 12, 14 is comprised of inner and end pipe engaging segments 16, 18. The end pipe engaging segments 18 of each assembly 12, 14 comprise an outwardly extending lug 30. The first and second assemblies 12, 14 connect to one another via their respective end pipe engaging segments 18. The first and second assemblies 12, 14 are connected together via fastening members, such as nut and bolt arrangements, 32, 34, at each end of the assemblies that pass through the lug 30 of the end pipe engaging segments 18.

As shown in FIGS. 7, 8-9, 11 and 12 the lug 30 is a mounting on the end pipe engaging segments 18 comprising an aperture 36 defining an opening to a passage 54 that extends through the lug. When the clamp is in use the aperture through the first lug 30a of the first end pipe engaging segment 18a of the first assembly aligns with the aperture through the first lug 30b of the first end pipe engaging segment 18b of the second assembly, and the aperture through the second lug 30c of the second end pipe engaging segment 18c on the first assembly aligns with the aperture through the second lug 30d of the second end pipe engaging segment 18d of the second assembly.

The surface on the lug can comprise a recess 38 for a washer 40 about the aperture 36 through which the shaft of the bolt 34 is passed. As shown in the FIG. 7 the recess 38 can be a hemispherical recess for receiving a corresponding hemispherical washer 40. The lugs of the first and second assemblies can both compress a recess for receiving the washers. Alternatively only the lugs of the first (top) assembly comprise the recess. The hemispherical washer comprises a hemispherical portion which extends into the corresponding recess in the surface of the lug and a flat outwardly facing face which engages the nut of the bolt when the clamp is connected.

The adjustable connecting members pass through the respective lugs. The connecting members are fasteners that can be tightened to close the clamp and secure the clamp about the pipes. As shown in FIG. 7-9 the connecting members can be a nut and threaded bolt arrangement driveable by the application of torque. As shown in FIG. 7 the shank of the bolt 34 passes through the washer 40 and aperture of a lug 30 of the first assembly 12 and then through the aperture and washer 40 of a lug 30 of the second assembly 14. Nuts 32 can be used to secure the bolt so as to clamp the two assemblies around the pipe hubs. Nuts can be used to secure the bolt at both ends of the bolt. At least one of the nuts may be a self-locking nut.

In one embodiment the fastening mechanism may be a Retlock® bolt (AFGlobal UK Ltd), which is known to those skilled in the art. The bolt extends through the passage of the lug and is driven by a nut on the top of the fastener.

Depending on the fastening mechanism used, the lugs on the end pipe engaging segments of the first assembly can be different from the lugs on the end engaging segments of the second assembly. In one embodiment the lugs of the end pipe engaging segments of the first assembly comprise an aperture and passage having a first configuration. The lugs of the end pipe engaging segments of the second assembly comprise an aperture and passage having a second configuration.

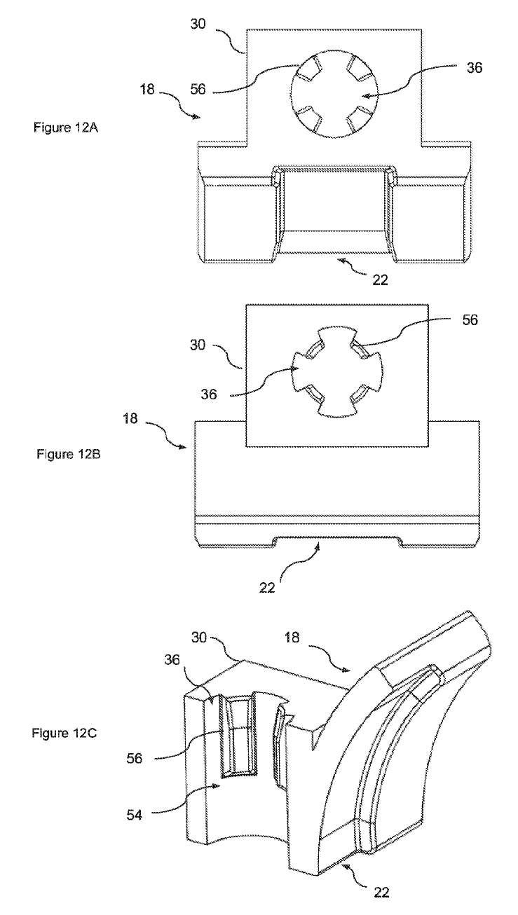

As shown in FIG. 11, in the first (top) assembly, which goes around the top of the pipe to be connected, the apertures 36 to receive the connecting member can be substantially circular openings in the top and bottom surfaces of the lugs 30. The top surface of the lug has a recess 38 about the aperture 36. The passage through the lug receives the fastening mechanism. As shown in FIG. 12, in the second (bottom) assembly, which goes around the bottom of the pipe to be connected, the aperture to receive the connecting member can be a substantially circular opening in the bottom (inner surface) of the lugs. The opening in the top (outer) surface of the lugs can be substantially cross-shaped. Protrusions 56 can extend from the walls of the passage 54 at the top of the lug to provide a substantially cross-shaped opening. The cross can have curved ends. The protrusions extend partially along the length of the passage. The bottom of the shaft of the bolt can have a corresponding cross shaped cross-section, which can mate with the protrusions in the lug.

When the nuts are tightened the ends of the two assemblies are brought together and the pipe engaging segments engage the hubs of the two pipes, securing the pipes together.

The material used to manufacture the clamp can depend on the pressure requirements. The band and pipe engaging segments can comprise steel and/or a steel alloy. The band and pipe engaging segments are composed of the same or different materials. In one embodiment different steel alloys can be used for the band and the pipe engaging segments. The pipe engaging segments can comprise the same material as the hubs.

The steel components may be coated with an antifriction coating. Locking can occur on shallow angles, the angle of locking depends upon the co-efficient of friction for the mating surfaces. Coatings providing a low coefficient of friction can be used on the surface of the pipe engaging segments and hubs. An inorganic lubricant such as molybdenum disulphide can be used.

In one embodiment a coating is used which provides a friction between the mating surfaces of about 0.02 to 0.06, preferably about 0.04. A friction coefficient of about 0.04 friction level will provide a friction locking angle of 2.3°.

In typical use the clamp assembly is securing a connection between conduits, or between a conduit and another subsea installation. The conduits have a flanged hub 26 having substantially flat faces having a sealing ring groove, in which a sealing ring 44 is located. The opposite faces of the hubs have a tapered surface which will engage with the tapered surfaces of pipe engaging segments of the clamp.

In use, the clamp is mounted to the hubs to be connected. The connecting members are tightened to close the clamp about the pipe hubs, such that when the clamp is closed the hubs are sealingly secured together.

The clamp's pipe engaging segments 16, 18, and the hubs 26 are configured such that tightening of the nuts 32 with a torque tool around the bolts 34 will move the segments 16, 18 inwardly relative to the hubs 26 such that the tapered surfaces 24 of the clamp's pipe engaging segments 16, 18 engage with the tapered surfaces of the hubs 26 and pull the hubs into sealing engagement with the seal ring 44 to complete the assembly of the connection.

Two torque tools can be used to tighten the two fastening mechanisms simultaneously. A first and a second torque tool are synchronised to tighten the nuts on the first and second fastening mechanisms on each side of the clamp. This can help obtain an even makeup between the two sides of the clamp.

The presence of the plurality of segments having a shallow angle, flexible bands, and the use of two connecting members allows the clamp to accommodate for tolerance during make up whilst requiring less torque to be applied and obtaining a more even stress distribution about the clamp.

Although the clamp is described with reference to securing the ends of two pipes together, the clamp can also be used to secure the end of a pipe to annular hubs of other subsea installations, such as on manifolds and wellheads.

### EXAMPLES

The induced stress on the components of the connection system was tested using a non-linear Finite Element analysis (FEA). Different angles of the hub and clamp segments were tested, with a band comprising a thickness of 35 mm.

The clamps are forced together onto the hubs using a controlled displacement approach and the results are shown in the Tables below:

| Hub taper angle | | 20° | 15° | 10° | 5° |
|---|---|---|---|---|---|
| Band | Peak Stress (MPa) | 1102 | 7958 | 582 | 430 |
| | Average Stress (MPa) | 172 | 101 | 54 | 25 |
| Hubs | Peak Stress (MPa) | 968 | 872 | 762 | 454 |
| | Average Stress (MPa) | 230 | 218 | 204 | 206 |
| Segments | Peak Stress (MPa) | 1127 | 674 | 427 | 317 |
| | Average Stress (MPa) | 165 | 138 | 85 | 30 |

| | Bolt Loading | | Minimum bolt |
|---|---|---|---|
| Hub Taper Angle | (N) | Metric ton force | diameter (mm) |
| 20° | 7.83E+006 | 799.29 | 146 |
| 15° | 5.95E+006 | 606.94 | 128 |
| 15° | 4.16E+006 | 424.8 | 107 |
| 5° | 2.45E+006 | 249.49 | 82 |

These results showed that acceptable levels of stress were induced where the hub angle was between 5° to 20°. The results also showed that the lower the angle the lower the induced stress in the components was. Therefore a lower bolt loading and thus a smaller shaft size of the bolt is required the smaller the tapered angle is.

1. A pipe connecting apparatus for clamping flanged ends of two pipes, the apparatus comprising:
a first assembly and a second assembly, each assembly comprising a plurality of pipe engaging segments connected by an outer band in an arcuate configuration, wherein each segment comprises a longitudinal arcuate channel having tapered side walls defining a channel for receiving the flanged ends; and
the apparatus further comprising two adjustable connecting members for connecting the first assembly to the second assembly, so as two clamp the assemblies around the flanged ends.

2. The pipe connecting apparatus according to claim 1 wherein the side walls are tapered at an angle of from about 5° to 22°.

3. The pipe connecting apparatus according to claim 2 wherein the side walls are tapered at an angle of from about 5° to 15°.

4. The pipe connecting apparatus according to claim 1 wherein the first assembly and second assembly each comprise three to five pipe engaging segments.

5. The pipe connecting apparatus according to claim 1 wherein the first assembly and second assembly each comprise four pipe engaging segments.

6. The pipe connecting apparatus according to claim 1 wherein both end pipe engaging segments of each assembly comprise a lug for receiving one of the connecting members.

7. The pipe connecting apparatus according to claim 6 wherein each lug comprises a recessed area and a hemispherical washer located within the recess area.

8. The pipe connecting apparatus according to claim 6 wherein apertures for receiving the connecting members through the lugs of the first assembly comprise a different configuration from apertures for receiving the connecting members through the lugs of the first assembly.

9. The pipe connecting apparatus according to claim 1 wherein the bands are connected to the segments by studs or bolts.

10. The pipe connecting apparatus according to claim 1 wherein the bands are connected to the segments by a key and keyway mechanism.

11. The pipe connecting apparatus according to claim 1 wherein the bands are connected to end pipe engaging segments by a first mechanism and the bands are connected to inner pipe engaging segments by a second mechanism, wherein the first and second mechanisms are different.

12. The pipe connecting apparatus according to claim 1 wherein the band and pipe engaging segments comprise a steel alloy.

13. The pipe connecting apparatus according to claim 1 wherein the band and pipe engaging segments are composed of different materials.

14. The pipe connecting apparatus according to claim 1 wherein the pipe engaging segments comprise an anti-friction coating.

15. The pipe connecting apparatus according claim 1 wherein the connecting members comprise a bolt and nut arrangement.

16. A method of securing a first pipe to a second pipe or further subsea installation comprising arranging the pipe connecting apparatus according to claim 1 around flanged hubs of the first pipe and second pipe or further installation; and applying torque to the connecting members of the pipe connecting apparatus to clamp the pipe connecting apparatus about the first pipe and second pipe or further installation.

17. A method according to claim 16 comprising engaging a torque device to each connecting member of the pipe connecting apparatus; and simultaneously applying torque to the first and second connecting members to clamp the pipe connecting apparatus about the pipe.
